(19) United States
(12) Patent Application Publication
(10) Pub. No.: US 2019/0325352 A1
(43) Pub. Date: Oct. 24, 2019

(54) OPTIMIZING FEATURE EVALUATION IN MACHINE LEARNING

(71) Applicant: Microsoft Technology Licensing, LLC, Redmond, WA (US)

(72) Inventors: Chang-Ming Tsai, Fremont, CA (US); Fei Chen, Saratoga, CA (US); Siyao Sun, Jersey City, NJ (US); Shihai He, Fremont, CA (US); Yu Gong, Santa Clara, CA (US); Scott A. Banachowski, Mountain View, CA (US); Joel D. Young, Milpitas, CA (US)

(73) Assignee: Microsoft Technology Licensing, LLC, Redmond, WA (US)

(21) Appl. No.: 15/959,023

(22) Filed: Apr. 20, 2018

(51) Int. Cl. G06N 99/00; G06F 17/30

(52) U.S. Cl. CPC G06N 99/005; G06F 17/30589

(57) ABSTRACT

The disclosed embodiments provide a system for processing data. During operation, the system obtains a feature dependency graph of features for a machine learning model and an operator dependency graph comprising operators to be applied to the features. Next, the system generates feature values of the features according to an evaluation order associated with the operator dependency graph and feature dependencies from the feature dependency graph. During evaluation of an operator in the evaluation order, the system updates a list of calculated features with one or more features that have been calculated for use with the operator. During evaluation of a subsequent operator in the evaluation order, the system uses the list of calculated features to omit recalculation of the feature(s) for use with the subsequent operator.

### RELATED APPLICATION

The subject matter of this application is related to the subject matter in a co-pending non-provisional application filed on the same day as the instant application, entitled “Unified Parameter and Feature Access in Machine Learning Models,” having serial number TO BE ASSIGNED, and filing date TO BE ASSIGNED (Attorney Docket No. LI-902222-US-NP).

### BACKGROUND

### Field

The disclosed embodiments relate to data analysis and machine learning. More specifically, the disclosed embodiments relate to techniques for optimizing feature evaluation in machine learning.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance

To glean such insights, large data sets of features may be analyzed using regression models, artificial neural networks, support vector machines, decision trees, naïve Bayes classifiers, and/or other types of machine learning models. The discovered information may then be used to guide decisions and/or perform actions related to the data. For example, the output of a machine learning model may be used to guide marketing decisions, assess risk, detect fraud, predict behavior, and/or customize or optimize use of an application or website.

However, significant time, effort, and overhead may be spent on feature selection during creation and training of machine learning models for analytics. For example, a data set for a machine learning model may have thousands to millions of features, including features that are created from combinations of other features, while only a fraction of the features and/or combinations may be relevant and/or important to the machine learning model. At the same time, training and/or execution of machine learning models with large numbers of features typically require more memory, computational resources, and time than those of machine learning models with smaller numbers of features. Excessively complex machine learning models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams. The same features may further be identified and/or specified multiple times during different steps associated with creating, training, validating, and/or executing the same machine learning model.

Consequently, creation and use of machine learning models in analytics may be facilitated by mechanisms for improving the monitoring, management, sharing, propagation, and reuse of features among the machine learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary operator dependency graph in accordance with the disclosed embodiments.

FIG. 4 shows a flowchart illustrating the processing of data in accordance with the disclosed embodiments.

FIG. 5 shows a flowchart illustrating a process of evaluating an operator during execution of a machine learning model in accordance with the disclosed embodiments.

FIG. 6 shows a flowchart illustrating a process of generating feature values of features for a machine learning model in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

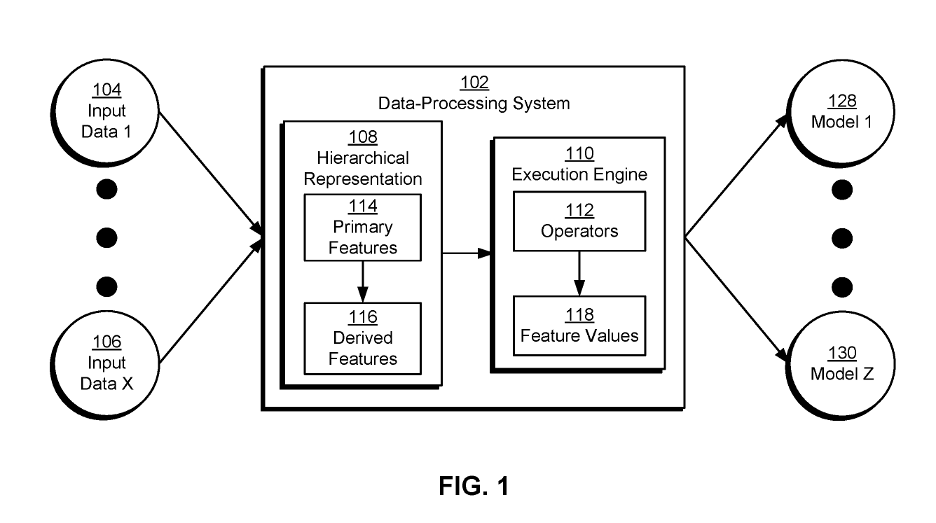

The disclosed embodiments provide a method, apparatus, and system for processing data. As shown in FIG. 1, the system includes a data-processing system 102 that analyzes one or more sets of input data (e.g., input data 1 104, input data x 106). For example, data-processing system 102 may create and train one or more machine learning models (e.g., model 1 128, model z 130) for analyzing input data related to users, organizations, applications, job postings, purchases, electronic devices, websites, content, sensor measurements, and/or other categories. The models may include, but are not limited to, regression models, artificial neural networks, support vector machines, decision trees, naïve Bayes classifiers, Bayesian networks, deep learning models, hierarchical models, and/or ensemble models.

In turn, the results of such analysis may be used to discover relationships, patterns, and/or trends in the data; gain insights from the data; and/or guide decisions or actions related to the data. For example, data-processing system 102 may use the machine learning models to generate output that includes scores, classifications, recommendations, estimates, predictions, and/or other properties or inferences.

The output may be inferred or extracted from primary features 114 in the input data and/or derived features 116 that are generated from primary features 114 and/or other derived features 116. For example, primary features 114 may include profile data, user activity, sensor data, and/or other data that is extracted directly from fields or records in the input data. The primary features 114 may be aggregated, scaled, combined, and/or otherwise transformed to produce derived features 116, which in turn may be further combined or transformed with one another and/or the primary features to generate additional derived features. After the output is generated from one or more sets of primary and/or derived features, the output is provided in responses to queries of data-processing system 102. In turn, the queried output may improve revenue, interaction with the users and/or organizations, use of the applications and/or content, and/or other metrics associated with the input data.

In one or more embodiments, primary features 114 and/or derived features 116 are obtained and/or used with a community of users, such as an online professional network that is used by a set of entities to interact with one another in a professional, social, and/or business context. The entities may include users that use the online professional network to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

As a result, primary features 114 and/or derived features 116 may include member features, company features, and/or job features. The member features include attributes from the members' profiles with the online professional network, such as each member's title, skills, work experience, education, seniority, industry, location, and/or profile completeness. The member features also include each member's number of connections in the social network, the member's tenure on the social network, and/or other metrics related to the member's overall interaction or “footprint” in the online professional network. The member features further include attributes that are specific to one or more features of the online professional network, such as a classification of the member as a job seeker or non-job-seeker.

The member features may also characterize the activity of the members with the online professional network. For example, the member features may include an activity level of each member, which may be binary (e.g., dormant or active) or calculated by aggregating different types of activities into an overall activity count and/or a bucketized activity score. The member features may also include attributes (e.g., activity frequency, dormancy, total number of user actions, average number of user actions, etc.) related to specific types of social or online professional network activity, such as messaging activity (e.g., sending messages within the social network), publishing activity (e.g., publishing posts or articles in the social network), mobile activity (e.g., accessing the social network through a mobile device), job search activity (e.g., job searches, page views for job listings, job applications, etc.), and/or email activity (e.g., accessing the social network through email or email notifications).

The company features include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features may relate to behavior or spending with a number of products, such as recruiting, sales, marketing, advertising, and/or educational technology solutions offered by or through the online professional network. For example, the company features may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within the online professional network.

The company features may also represent a company's level of engagement with and/or presence on the online professional network. For example, the company features may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, recruiting, executive, etc.) who are members of the online professional network. The company features may also include the number of online professional network members at the company with connections to employees of the online professional network, the number of connections among employees in the company, and/or the number of followers of the company in the online professional network. The company features may further track visits to the online professional network from employees of the company, such as the number of employees at the company who have visited the online professional network over a recent period (e.g., the last 30 days) and/or the same number of visitors divided by the total number of online professional network members at the company.

One or more company features may additionally be derived features 116 that are generated from member features. For example, the company features may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, the company features may be used to glean company-level insights or trends from member-level online professional network data, perform statistical inference at the company and/or member segment level, and/or guide decisions related to business-to-business (B2B) marketing or sales activities.

The job features describe and/or relate to job listings and/or job recommendations within the online professional network. For example, the job features may include declared or inferred attributes of a job, such as the job's title, industry, seniority, desired skill and experience, salary range, and/or location. One or more job features may also be derived features 116 that are generated from member features and/or company features. For example, the job features may provide a context of each member's impression of a job listing or job description. The context may include a time and location (e.g., geographic location, application, website, web page, etc.) at which the job listing or description is viewed by the member. In another example, some job features may be calculated as cross products, cosine similarities, statistics, and/or other combinations, aggregations, scaling, and/or transformations of member features, company features, and/or other job features.

In one or more embodiments, data-processing system 102 uses a hierarchical representation 108 of features 114 and derived features 116 to organize the sharing, production, and use of the features across different teams, execution environments, and/or projects. Hierarchical representation 108 may include a directed acyclic graph (DAG) that defines a set of namespaces for primary features 114 and derived features 116. The namespaces may disambiguate among features with similar names or definitions from different usage contexts or execution environments. Hierarchical representation 108 may include additional information that can be used to locate primary features 114 in different execution environments, calculate derived features 116 from the primary features and/or other derived features, and track the development of machine learning models or applications that accept the derived features as input.

For example, primary features 114 and derived features 116 in hierarchical representation 108 may be uniquely identified by strings of the form “[entityName].[fieldname]” The “fieldname” portion may include the name of a feature, and the “entityName” portion may form a namespace for the feature. Thus, a feature name of “skills” may be appended to namespaces such as “member,” “company,” and/or “job” to disambiguate between features that share the feature name but are from different teams, projects, sources, feature sets, contexts, and/or execution environments.

In one or more embodiments, data-processing system 102 uses an execution engine 110 and a set of operators 112 to generate and/or modify sets of feature values 118 that are inputted into the machine learning models and/or used as scores that are outputted from the machine learning models. For example, data-processing system 102 may use execution engine 110 to obtain and/or calculate feature values 118 of primary features 114 and/or derived features 116 for a machine learning model. Data-processing system 102 may use operators 112 to filter, order, limit, extract, group, deduplicate, apply set operations to, and/or otherwise modify lists or sets of feature values 118 prior to outputting some or all feature values 118 as scores from the machine learning model. In addition, data-processing system 102 may calculate feature values 118 and/or apply operators 112 in a way that avoids repeated and/or unnecessary calculation of feature values 118 while increasing the efficiency with which multiple sets of feature values 118 are calculated from multiple documents.

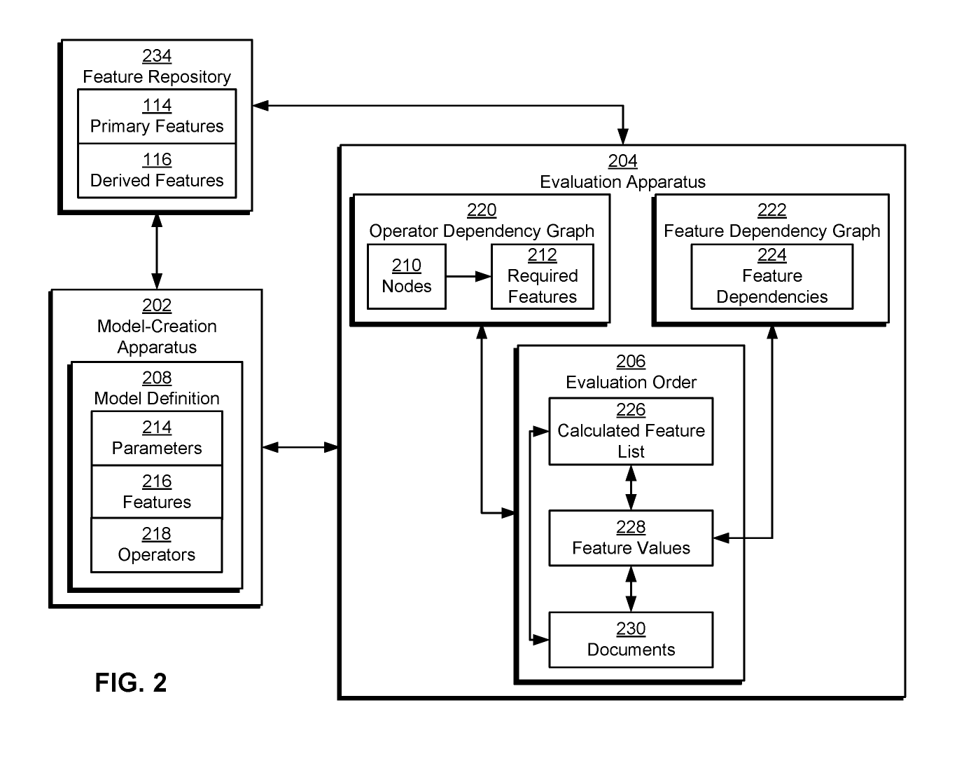

As shown in FIG. 2, a system for processing data (e.g., data-processing system 102 of FIG. 1) includes a model-creation apparatus 202 and an evaluation apparatus 204. Each of these components is described in further detail below.

Model-creation apparatus 202 obtains a model definition 208 for a machine learning model. For example, model-creation apparatus 202 may obtain model definition 208 from one or more configuration files, user-interface elements, and/or other mechanisms for obtaining user input and/or interacting with a user.

Model definition 208 defines parameters 214, features 216, and operators 218 used with the machine learning model. Features 216 may include primary features 114 and/or derived features 116 that are obtained from a feature repository 234 and/or calculated from other features, as described above. For example, model definition 208 may include names, types, and/or sources of features 216 inputted into the machine-learning model.

Parameters 214 may specify the names and types of regression coefficients, neural network weights, and/or other attributes that control the behavior of the machine-learning model. As a result, parameters 214 may be set and/or tuned based on values of features 216 inputted into the machine learning model. After values of parameters 214 are assigned (e.g., after the machine learning model is trained), parameters 214 may be applied to additional values of features 216 to generate scores and/or other output of the machine learning model.

Operators 218 may specify operations to be performed on lists or sets of documents 230 representing entities and/or features used with the machine learning model. For example, a document may include features that represent a member, job, company, and/or other entity. The document may be represented using a row or record in a database and/or other data store, with columns or fields in the row or record containing data for the corresponding features. During execution of the machine learning model, data in a set of documents 230 may be obtained as input to generate additional features such as derived features 116 and/or scores representing output of the machine learning model. The additional features and/or scores may be stored in additional sets of documents 230 and/or additional columns in the input documents 230, and operators 218 may be applied to one or more sets of documents 230 before returning some or all documents 230 as output of the machine learning model.

Operators 218 may include a sort operator, a filtering operator, a grouping operator, a union operator, a limit operator, a deduplication operator, an extraction operator, and/or a user-defined operator. The sort operator may order the documents by a feature or other value. For example, the sort operator may be used to order a list of documents 230 by ascending or descending feature values in the documents.

The filtering operator may filter documents in the list by a feature value. For example, the filtering operator may remove a document from a list of documents if the value of a Boolean feature in the document is false and keep the document in the list if the value of the Boolean feature in the document is true. In another example, the filtering operator may filter documents from a list based on a statement that evaluates to true or false for one or more feature values in each document.

The grouping operator may group a list of documents by one or more features. The output of the grouping operator may include a list of document groups, with each document group containing a separate list of documents. The grouping operator may also produce a count of documents in each document group. For example, the grouping operator may group a list of jobs by job title, location, and/or other attributes of the jobs. The grouping operator may also generate a count of jobs in each group as additional output of the operator.

The union operator may apply a union operation to two or more input lists of documents and return a single list of documents containing all documents that were in the input lists. The deduplication operator may deduplicate documents in a list by retaining only one document in a set of duplicated documents (e.g., documents with the exact same features and/or values) within the list.

The limit operator may restrict the number of documents in a list to a specified number. For example, the limit operator may be applied to a set of documents before the set is returned as output from the machine learning model. The limit operator may additionally select the specified number of documents to retain in the list according to the ordering of documents in the list and/or feature values of one or more features in the documents. For example, the limit operator may be used to return the first 100 documents in the list and/or 100 documents from the list with the highest or lowest values of a given feature.

The extract operator may extract specific fields and/or features from documents in a list. For example, the extract operator may be called or invoked with a list of documents and a list of features to be extracted from the documents. In turn, the extract operator may return a new and/or modified list of documents containing the extracted features.

The user-defined operator may include a class, object, expression, formula, and/or operation to be applied to one or more lists of documents. As a result, the user-defined operator may be called with a fully qualified name of the class, object, expression, formula, and/or operation and/or the content of the class, object, expression, formula, and/or operation.

An exemplary model definition 208 for a machine-learning model may include the following:

IMPORT com.linkedin.quasar.interpreter.SampleFeatureProducers;
MODELID “quasar_test_model”;
MODEL PARAM Map<String, Object> scoreWeights = { };
MODEL PARAM Map<String, Object> constantWeights = {

“extFeature5” : {“term1”: 1.0, “term2”:
2.0, “term3”: 3.0}

};
DOCPARAM String lijob;
EXTERNAL REQUEST FEATURE Float extFeature1 WITH NAME
“e1” WITH
KEY “key”;
EXTERNAL REQUEST FEATURE Float extFeature2 WITH NAME
“e2” WITH
KEY “key”;
EXTERNAL DOCUMENT FEATURE VECTOR<SPARSE>
extFeature3 WITH
NAME “e3” WITH KEY “key”;
EXTERNAL DOCUMENT FEATURE VECTOR<SPARSE>
extFeature4 WITH
NAME “e4” WITH KEY “key”;
EXTERNAL DOCUMENT FEATURE VECTOR<SPARSE>
extFeature5 WITH
NAME “e5” WITH KEY “key”;
REQUEST FEATURE float value3 =
SampleFeatureProducers$DotProduct(extFeature1, extFeature2);
DOCUMENT FEATURE float value4 =
SampleFeatureProducers$DotProduct(extFeature2, extFeature3);
DOCUMENT FEATURE float score =
SampleFeatureProducers$MultiplyScore(value3, value4, extFeature3);
orderedJobs = ORDER DOCUMENTS BY score WITH DESC;
returnedJobs = LIMIT orderedJobs COUNT 20;
RETURN returnedJobs;

The exemplary model definition 208 above includes a model name of “quasar_test_model.” The exemplary model definition 208 also specifies two sets of parameters 214: a first set of “scoreWeights” with values to be set during training of the model and a second set of “constantWeights” with names of “term1,” “term2,” and “term3” and corresponding fixed values of 1.0, 2.0, and 3.0. The exemplary model definition 208 further includes a “DOCPARAM” statement with a data type of “String” and a variable name of “lijob.” The statement may thus define documents used with the model as containing string data types and identify the documents using the variable name of “lijob.”

The exemplary model definition 208 also includes a series of requests for five external features named “extFeature1,” “extFeature2,” “extFeature3,” “extFeature4,” and “extFeature5.” The first two features have a type of “Float,” and the last three features have a type of “VECTOR<SPARSE>.” The external features may be primary features 114 and/or derived features 116 that are retrieved from a feature repository (e.g., feature repository 234) named “SampleFeatureProducers” using the corresponding names of “e1,” “e2,” “e3,” “e4,” and “e5” and the same key of “key.”

The exemplary model definition 208 further specifies a set of derived features 116 that are calculated from the five external features. The set of derived features 116 includes a feature with a name of “value3” and a type of “float” that is calculated as the dot product of “extFeature1” and “extFeature2.” The set of derived features 116 also includes a feature with a name of “value4” and a type of “float” that is calculated as the dot product of “extFeature2” and “extFeature3.” The set of derived features 116 further includes a feature with a name of “score” and a type of “float” that is calculated using a function named “MultiplyScore” and arguments of “value3,” “value4,” and “extFeature3.” The “extFeature3,” “extFeature4,” “extFeature5,” “value4,” and “score” features are defined as “DOCUMENT” features, indicating that values of the features are to be added to different columns of the documents.

Finally, the exemplary model definition 208 includes a first operator that orders the documents by “score” and a second operator that limits the ordered documents to 20. After the operators are sequentially applied to the documents, the exemplary model definition 208 specifies that the documents be returned as output of the model.

Those skilled in the art will appreciate that calculating features 216 according to the declaration of features 216 and/or the use of features 216 with operators 218 in model definition 208 may result in unnecessary and/or repeated feature calculations. For example, a feature that is declared in model definition 208 but not used as input to and/or output of the machine learning model may be calculated unnecessarily during conventional model execution. In another example, conventional model execution may repeatedly calculate a feature for each operator that uses the feature, even if the same feature values 228 for the feature are inputted into all operators that use the feature.

In one or more embodiments, the system of FIG. 2 includes functionality to optimize feature evaluation by reducing overhead associated with unnecessary feature calculation and/or recalculation. First, evaluation apparatus 204 creates and/or obtains an operator dependency graph 220 and a feature dependency graph 222 for generating and/or modifying sets or lists of features 216 in model definition 208.

Evaluation apparatus 204 may create operator dependency graph 220 as a DAG from operators 218 declared in model definition 202. Nodes of operator dependency graph 220 may have dependencies on one another based on the order in which operators 218 are applied to the corresponding features 216 in model definition 208. For example, the sequential application of three operators 218 to a given feature may be reflected in operator dependency graph 220 as a path containing three nodes that are sequentially connected by two directed edges.

Each node in operator dependency graph 210 may additionally specify a set of required features 212 associated with the corresponding operator. For example, required features 212 may include sets of features to which the operator is to be applied, as indicated in model definition 208. Required features 212 may also, or instead, include sets of features that require calculation and/or materialization after the operator has been evaluated (e.g., for use with operators that have dependencies on the operator). In other words, required features 212 may identify features to be calculated before or after a given operator is evaluated.

Similarly, evaluation apparatus 204 may create feature dependency graph 222 as a DAG from features 216 declared in model definition 208. Feature dependencies 224 in feature dependency graph 222 may reflect the calculation of certain features 216 from other features 216, as described in model definition 208. For example, a feature that is declared as calculated from two other features in model definition 208 may be represented as a node in feature dependency graph 222 that is connected via directed edges to two other nodes representing the other features.

Next, evaluation apparatus 204 uses operator dependency graph 220 and feature dependency graph 222 to generate and/or modify feature values 228 of features 216 declared in model definition 208. In particular, evaluation apparatus 204 may use operator dependency graph 220 to derive an evaluation order 206 associated with operators 218. For example, evaluation apparatus 204 may generate evaluation order 206 to reflect the order in which operators 218 are to be applied to features 216 in model definition 208.

After evaluation order 206 is determined, evaluation apparatus 204 may generate feature values 228 of features 216 based on evaluation order 206 and/or feature dependencies 224 in feature dependency graph 222. More specifically, evaluation apparatus 204 may evaluate operators 218 in model definition 218 according to evaluation order 206. Prior to or during evaluation of a given operator, evaluation apparatus 204 may generate feature values 228 of required features 212 for the operator.

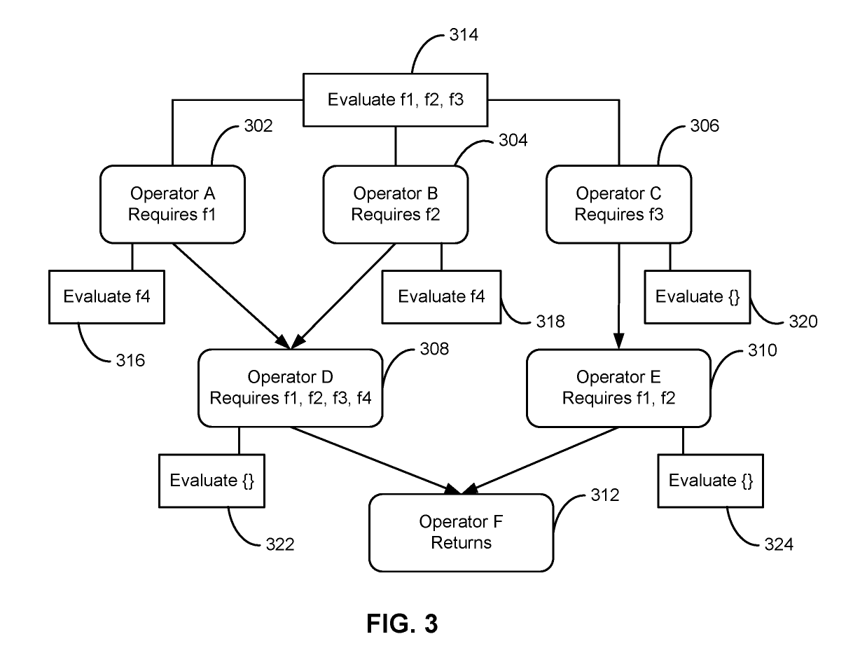

As mentioned above, required features 212 may represent features 216 that are to be calculated before the operator is applied to the features and/or after the operator has been applied to other features. For example, each set of required features 212 may be stored in and/or associated with a given node in operator dependency graph 220. When the set of required features 212 represents features 216 that are inputted into a given operator, feature values 228 of the set of required features 212 may be calculated when the node representing the operator is reached in evaluation order 206. Conversely, when the set of required features 212 represents features 216 to be calculated after the operator has been evaluated, feature values 228 of the set of required features 212 may be calculated prior to evaluating child nodes of the operator. Representing and/or identifying required features using nodes of operator dependency graphs is described in further detail below with respect to FIG. 3.

To generate feature values 228 for use with an operator in evaluation order 206, evaluation apparatus 204 may retrieve feature values 228 from a set of documents 230 in feature repository 234 and/or another data source specified in model definition 208; use a method or function call to obtain feature values 228 and/or documents 230 from a library or application-programming interface (API); and/or apply an expression, operation, or formula to documents 230 and/or feature values 228 to produce additional feature values 228. Evaluation apparatus 204 may also, or instead, use feature dependency graph 222 to identify feature dependencies 224 of one or more required features 212, obtain or calculate feature values 228 of features 216 represented by the identified feature dependencies 224, and use the calculated feature values 228 to calculate feature values 228 of one or more required features 212.

After feature values 228 of required features 212 for an operator are produced, evaluation apparatus 204 may apply the operator to one or more lists of documents 230 containing required features 212. For example, evaluation apparatus 204 may use the operator to combine multiple lists of documents 230 into a single document list and/or group documents within a document list into multiple document lists. Evaluation apparatus 204 may also, or instead, use the operator to filter, order, limit, deduplicate, and/or apply a user-defined function to documents 230 within a list.

While operators 218 are evaluated according to evaluation order 206, evaluation apparatus 204 maintains a calculated feature list 226 that tracks the calculation of features 216 used with operators 218. Evaluation apparatus 204 then compares calculated feature list 226 with required features 212 for a given operator from operator dependency graph 220 to determine additional features 216 to be calculated for the operator and/or prevent previously calculated features from being recalculated for use with the operator.

For example, calculated feature list 226 may contain a set of features that have been calculated during execution of the machine learning model. After a given feature is calculated, evaluation apparatus 204 may add the feature name and/or another unique identifier for the feature to calculated feature list 226. In another example, calculated feature list 226 may include a flag for each required feature in operator dependency graph 220 and/or each feature in model definition 208. After a given feature is calculated, evaluation apparatus 204 may change the flag for the feature in calculated feature list 226 to indicate that the feature has been calculated.

Calculated feature list 226 may also track the calculation of features 216 from specific documents 230. For example, calculated feature list 226 may indicate one or more sets of documents used to calculate a given feature.

Evaluation apparatus 204 then uses calculated feature list 226 and required features 212 from operator dependency graph 220 to reduce computational overhead and/or inefficiency associated with calculating feature values 228 and/or applying operators 218 to the calculated feature values 228. When a given operator is reached in evaluation order 206, evaluation apparatus 204 may obtain required features 212 for the operator from operator dependency graph and compare required features 212 to calculated feature list 226. Evaluation apparatus 204 may then remove, from required features 212, one or more features that have already been calculated according to calculated feature list 226 (e.g., if the same documents are used to calculate the feature(s) for the operator and one or more preceding operators in evaluation order 206).

For example, evaluation apparatus 204 may apply a set difference operation to required features 212 and calculated feature list 226 to remove previously calculated features from required features 212. Evaluation apparatus 204 may then obtain and/or calculate feature values 228 for the remaining required features 212 before applying the operator to the newly calculated and previously calculated feature values 228 of required features 212. Consequently, calculated feature list 226 and required features 212 for each operator may allow evaluation apparatus 204 to avoid calculating features that are not used with the machine learning model and/or recalculating features that have already been calculated during evaluation of previous operators in evaluation order 206.

On the other hand, evaluation apparatus 204 may omit use of calculated feature list 226 during evaluation of operators 218 when a tree structure in operator dependency graph 220 is detected. In particular, the tree structure and/or another linear flow of operators 218 may have only one path from the highest level of operator dependency graph 220 to each leaf node in operator dependency graph 220. As a result, required features 212 for nodes 210 in the path may be used to track calculation of feature values 228 in lieu of calculated feature list 226 (e.g., since any required features 212 of an operator have either been calculated in preceding operators in the path or need to be calculated for use with the operator).

To further streamline calculation of feature values 228, evaluation apparatus 204 uses calculated feature list 226, required features 212, and/or feature dependencies 224 to determine an ordering of features 216 to be calculated using a single set of documents 230. Evaluation apparatus 204 then calculates feature values 228 of the features according to the ordering. In particular, evaluation apparatus 204 iterates through the set of documents 230 and calculates an entire set of feature values 228 for a feature before repeating the process with the next feature in the ordering.

For example, evaluation apparatus 204 may use required features 212 and calculated feature list 226 to identify one or more required features 212 to be calculated from the same set of documents 230 before an operator is applied to required features 212. Evaluation apparatus 204 may also use feature dependencies 224 to identify additional features as dependencies of the identified required features 212 and order the identified features in a way that satisfies feature dependencies 224. Evaluation apparatus 204 may then use an “outer loop” to iterate through the identified features and an “inner loop” to iterate through the set of documents and calculate a feature value for each document. Consequently, the same feature computation may be applied to all documents in the set to produce a set of feature values 228 for one feature before a different feature computation is applied to all documents in the set to produce another set of feature values 228.

In other words, evaluation apparatus 204 may perform column-order evaluation of feature values 228, in which the same feature computation function is applied to all documents 230 to generate an additional column of feature values 228 in documents 230. Such column-order evaluation may expedite feature calculations by allowing the feature computation function to be accessed from a warm cache and/or enabling batch processing of feature values 228 from documents 230.

Column-order evaluation of feature values 228 may be illustrated using the following example computation flow:

In the above computation flow, each document (“doc”) is conceptually represented as a row, and each feature (“member,” “news feed,” “interest”, “category,” “match”) is conceptually represented as a column. As a result, all feature values for a given feature may be calculated from the documents before all feature values for a different feature are calculated. For example, the column-order evaluation may calculate all “member” feature values from all documents, followed by all “news feed” feature values from all documents. The column-order evaluation may then calculate all “interest” feature values from all documents, followed by all “category” feature values from all documents. Finally, the column-order evaluation may calculate all “match” feature values from all documents.

In contrast, conventional feature-evaluation techniques may perform row-order evaluation of feature values, in which an “inner loop” is used to calculate a set of features from a single document before an “outer loop” is used to iterate through a set of documents for which the same set of features is calculated. Row-order evaluation of feature values 228 may be illustrated using the following example computation flow:

doc₁: member→news feed→interest→category→match

doc₂: member→news feed→interest→category→match

doc₃: member→news feed→interest→category→match

doc₄: member→news feed→interest→category→match

In the above computation flow, individual feature values are calculated for a set of features named “member,” “news feed,” “interest”, “category,” and “match” from a given document (“doc”) before the feature values are calculated for the same set of features from the next document. For example, the row-order evaluation may sequentially calculate feature values for the “member,” “news feed,” “interest,” “category,” and “match” features from “doc₁” before sequentially calculating feature values for the “member,” “news feed,” “interest,” “category,” and “match” features from “doc₂.” The row-order evaluation may then sequentially calculate feature values for the “member,” “news feed,” “interest”, “category,” and “match” features from “doc₃” before sequentially calculating feature values for the “member,” “news feed,” “interest”, “category,” and “match” features from “doc₄.” Because such row-order evaluation requires switching between different functions to calculate different feature values, efficiency gains from both caching of feature computations and batch processing of feature values from a set of documents are precluded.

By tracking required features 212 for operators 218 and previously calculated features during execution of a machine learning model, the system of FIG. 2 may reduce overhead associated with unnecessary calculation of unused features and/or previously calculated features. The system may additionally perform column-order evaluations of feature values 228 that enable execution of feature computation functions from caches and batch processing of multiple sets of feature values 228 from a set of documents 230. Consequently, the system may improve technologies for executing machine-learning models and/or calculating feature values for the machine learning models, as well as applications, distributed systems, and/or computer systems that execute the technologies and/or machine-learning models.

Those skilled in the art will appreciate that the system of FIG. 2 may be implemented in a variety of ways. First, model-creation apparatus 202, evaluation apparatus 204, and/or feature repository 234 may be provided by a single physical machine, multiple computer systems, one or more virtual machines, a grid, one or more databases, one or more filesystems, and/or a cloud computing system. Model-creation apparatus 202 and evaluation apparatus 204 may additionally be implemented together and/or separately by one or more hardware and/or software components and/or layers. Moreover, various components of the system may be configured to execute in an offline, online, and/or nearline basis to perform different types of processing related to creating and/or executing machine-learning models.

Second, model definition 208, operator dependency graph 220, feature dependency graph 222, primary features 114, derived features 116, feature values 228, documents 230, and/or other data used by the system may be stored, defined, and/or transmitted using a number of techniques. For example, the system may be configured to accept features 216 from different types of repositories, including relational databases, graph databases, data warehouses, filesystems, online services, and/or flat files. The system may also obtain and/or transmit model definition 208, feature values 228, and/or documents 230 in a number of formats, including database records, property lists, Extensible Markup Language (XML) documents, JavaScript Object Notation (JSON) objects, source code, and/or other types of structured data.

FIG. 3 shows an exemplary operator dependency graph in accordance with the disclosed embodiments. The operator dependency graph includes a set of operator nodes 302-312 representing operators to be applied during execution of a machine learning model. Each operator node includes an identifier for the corresponding operator and one or more features required by the operator. Node 302 has an identifier of “A” and requires a feature named “f1,” node 304 has an identifier of “B” and requires a feature named “f2,” and node 306 has an identifier of “C” and requires a feature named “f3.” Node 308 has an identifier of “D” and requires features named “f1,” “f2,” “f3,” and “f4,” and node 310 has an identifier of “E” and requires features named “f1” and “f2.” Finally, node 312 has an identifier of “F” that returns from execution instead of requiring additional features.

Edges between operator nodes 302-312 may be used to derive an evaluation order for the operator dependency graph. For example, the edges may indicate that operators “A,” “B,” and “C” are to be evaluated first, followed by operators “D” and “E,” and finally concluding with operator “F.”

Features required by the operators may be aggregated into feature nodes 314-324 attached to and/or included in parent nodes of operator nodes 302-312, in lieu of or in addition to storing individual sets of required features at individual operator nodes 302-312. As a result, each feature node 314-324 may identify one or more features that are to be calculated before one or more operator nodes 302-312 (e.g., child nodes of the operator node with which the feature node is associated) can be evaluated.

In particular, feature node 314 contains features “f1,” “f2,” and “f3” that are required by operators “A,” “B,” and “C.” Because feature node 314 is positioned above operator nodes 302-306, features identified in feature node 314 may be calculated before operators represented by operator nodes 302-306 are evaluated.

In turn, feature nodes 316-320 attached to operator nodes 302-306 contain features that are required by operators represented by operator nodes 308-310 that are children of operator nodes 302-306. As a result, feature nodes 316-318 contain feature “f4,” which is required by operator node 308 along with features “f1,” “f2,” and “f3.” Because calculation of “f1,” “f2,” and “f3” is performed before operators represented by operator nodes 302-306 are evaluated, feature nodes 316-318 may omit “f1,” “f2,” and “f3.” Feature node 320 is attached to operator node 306 and contains required features for operator “E,” which is represented by operator node 310 that is the only child of operator node 306. Feature node 320 contains an empty set of features because features “f1” and “f2” required by operator “E” have already been calculated by the time operator “E” is reached in the evaluation order.

Finally, feature nodes 322-324 attached to operator nodes 308-310 contain features that are required by the operator represented by operator node 312, which is the child node of operator nodes 308-310. Because operator node 312 does not specify any required features for operator “F,” both feature nodes 322-324 may include an empty set of features.

Merging of required features for the operators into feature nodes 314-324 associated with parent nodes of the corresponding operator nodes 302-312 may reduce the number of required features associated with each operator, the number of lists of required features to maintain, and/or comparison of the required features with a calculated feature list (e.g., calculated feature list 226 of FIG. 2). For example, three sets of required features from operator nodes 302-306 may be merged into a single set of features to be calculated before operators “A,” “B,” and “C” are evaluated. Along the same lines, required features for operator nodes 310-312 may be resolved using previously calculated features, thus omitting lists of required features for operator nodes 310-312 and/or parent nodes of operator nodes 310-312. In turn, the reduction in the number of lists of required features and/or the overall number of required features may reduce memory overhead associated with storing the lists and/or computational overhead associated with updating the required features based on the calculated feature list.

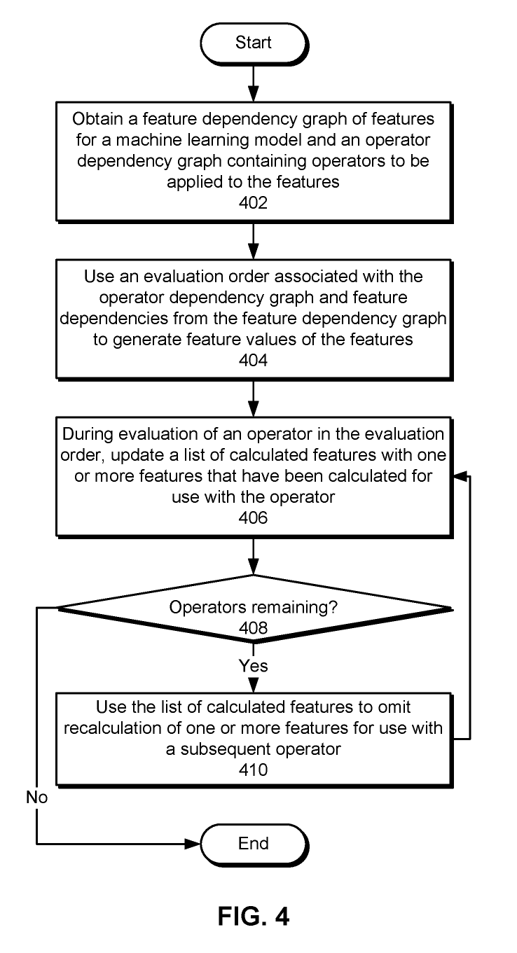

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a feature dependency graph of features for a machine learning model and an operator dependency graph containing operators to be applied to the features are obtained (operation 402). For example, a model definition containing feature declarations of the features and applications of the operators to the features may be obtained. The feature dependency graph may be created from the feature declarations, and the operator dependency graph may be generated from the applications of the operators to the features.

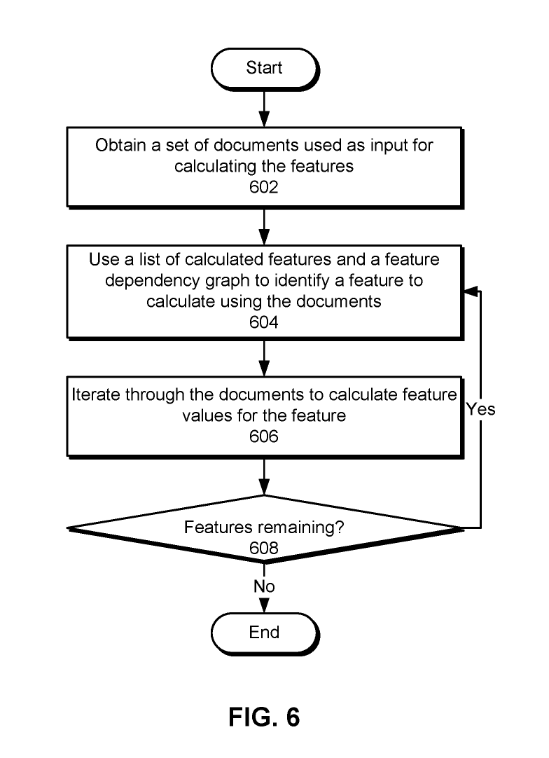

Next, an evaluation order associated with the operator dependency graph and feature dependencies from the feature dependency graph are used to generate feature values of the feature (operation 404). For example, the evaluation order may be determined so that operators that are applied earlier to a given feature in the model definition are evaluated before operators that are applied later to the feature in the model definition. The feature values may also be generated using a column-order evaluation of a set of documents, as described in further detail below with respect to FIG. 6.

After the evaluation order is determined, feature values for features inputted into an operator may be generated prior to or during evaluation of the operator in the evaluation order. In turn, a list of calculated features is updated with one or more features that have been calculated for use with the operator (operation 406).

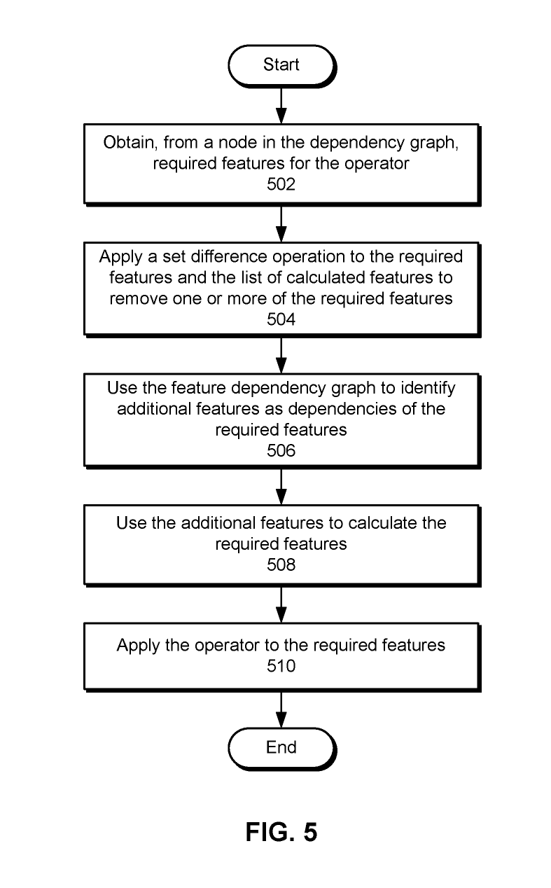

Evaluation of features and/or operators may continue with remaining operators (operation 408) in the evaluation order. When an operator is reached in the evaluation order, the list of calculated features is used to omit recalculation of one or more features for use with the operator (operation 410). The list is subsequently updated with one or more other features that have been calculated for use with the operator (operation 406) during evaluation of the operator, as discussed in further detail below with respect to FIG. 5.

Calculating and/or omitting the calculation of feature values using the list of calculated features may continue for remaining operators in the evaluation order (operations 406-410). After all operators in the evaluation order have been evaluated, one or more sets of feature values may be returned as output from the machine learning model.

FIG. 5 shows a flowchart illustrating a process of evaluating an operator during execution of a machine learning model in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, required features for the operator are obtained from a node in the dependency graph (operation 502). The node may represent the operator and/or the parent node of the node representing the operator. If the required features are obtained from a node representing the operator, the required features may include features that are used with and/or inputted into the operator. If the required features are obtained from a parent node of the node representing the operator, the required features may include required features for the operator, as well as additional required features for other operators represented by other child nodes of the parent node.

Next, a set difference operation is applied to the required features and a list of calculated features to remove one or more of the required features (operation 504). For example, the set difference operation may replace the set of required features with a subset of the required features that are not found in the list of calculated features.

The feature dependency graph is then used to identify additional features as dependencies of the required features (operation 506). For example, nodes and/or edges in the feature dependency graph may indicate that one or more of the required features are calculated from one or more additional features. In turn, the additional features are used to calculate the required features (operation 508). One or more required features may also, or instead, be calculated using feature values and/or other values in a set of documents, as described in further detail below with respect to FIG. 6.

Finally, the operator is applied to the required features (operation 510). For example, the operator may be used to merge multiple sets of features into a single set of features and/or divide a single set of features into multiple sets of features. The operator may also, or instead, sort the features in a set, filter the features in a set, limit the number of features in a set, deduplicate features in a set, extract one or more features from a set of documents, and/or apply a user-defined function to one or more sets of features.

FIG. 6 shows a flowchart illustrating a process of generating feature values of features for a machine learning model in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

First, a set of documents used as input for calculating the features is obtained (operation 602). For example, the documents may be obtained from a data source. Prior to obtaining the documents, the documents may optionally be modified using other sets of features and/or operators.

Next, a list of calculated features and a feature dependency graph are used to identify a feature to calculate using the documents (operation 604). For example, a set of required features for an operator and/or the machine learning model may be obtained. The required features may be limited to features that can be calculated from the same set of documents. The required features may also be supplemented and/or ordered based on feature dependencies from the feature dependency graph. As a result, the feature obtained in operation 604 may represent the highest feature in the order that has not yet been calculated.

Next, feature values for the feature are calculated by iterating through the documents (operation 606). For example, the same feature calculation function or operation may be loaded and applied to each document to produce an additional column in the documents that contains feature values of the feature. Operation 604-606 may be repeated for remaining features (operation 608) that can be calculated from the set of documents. As a result, sets of feature values for individual features may be calculated sequentially instead of calculating sets of different features for individual documents on a sequential basis.

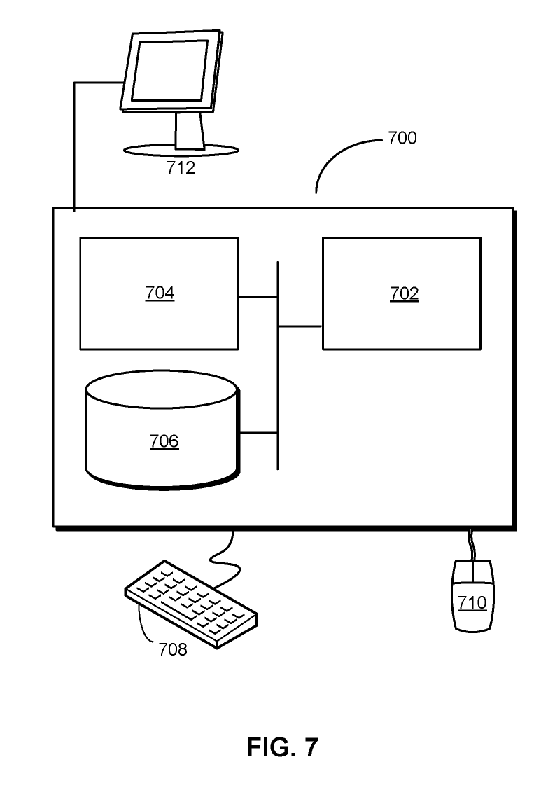

FIG. 7 shows a computer system 700. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing data. The system includes a model-creation apparatus and an evaluation apparatus, one or more of which may alternatively be termed or implemented as a module, mechanism, or other type of system component. The model-creation apparatus obtains and/or generates a feature dependency graph of features for a machine learning model and an operator dependency graph comprising operators to be applied to the features. Next, the evaluation apparatus generates feature values of the features according to an evaluation order associated with the operator dependency graph and feature dependencies from the feature dependency graph. During evaluation of an operator in the evaluation order, the evaluation apparatus updates a list of calculated features with one or more features that have been calculated for use with the operator. During evaluation of a subsequent operator in the evaluation order, the evaluation apparatus uses the list of calculated features to omit recalculation of the feature(s) for use with the subsequent operator.

In addition, one or more components of computer system 700 may be remotely located and connected to the other components over a network. Portions of the present embodiments (e.g., model-creation apparatus, evaluation apparatus, feature repository, etc.) may also be located on different nodes of a distributed system that implements the embodiments. For example, the present embodiments may be implemented using a cloud computing system that evaluates features and/or operators for a set of remote statistical models.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a feature dependency graph of features for a machine learning model and an operator dependency graph comprising operators to be applied to the features;
generating, by a computer system, feature values of the features according to an evaluation order associated with the operator dependency graph and feature dependencies from the feature dependency graph;
during evaluation of an operator in the evaluation order, updating a list of calculated features with one or more features that have been calculated for use with the operator; and
during application of a subsequent operator in the evaluation order to the feature values, using the list of calculated features to omit recalculation of the one or more features for use with the subsequent operator.

2. The method of claim 1, wherein obtaining the feature dependency graph and the operator dependency graph comprises:
obtaining a model definition comprising feature declarations of the features and applications of the operators to the features;
generating the feature dependency graph from the feature declarations; and
generating the operator dependency graph from the applications of the operators to the features.

3. The method of claim 1, wherein applying the operators to the features according to the evaluation order and the feature dependencies comprises:
obtaining, from a node in the operator dependency graph, a set of required features for the operator; and
applying the operator to the set of required features.

4. The method of claim 3, wherein applying the operators to the features according to the evaluation order and the feature dependencies further comprises:
using the feature dependency graph to identify additional features as dependencies of the set of required features; and
using the additional features to calculate the set of required features.

5. The method of claim 3, wherein the node comprises at least one of:
a parent node of the operator; and
the operator.

6. The method of claim 5, wherein obtaining the set of required features for the operator comprises:
obtaining, from the parent node of the operator, the set of required features with additional required features for other child nodes of the parent node.

7. The method of claim 1, wherein using the list of calculated features to omit recalculation of the one or more features for use with the subsequent operator comprises:
applying a set difference operation to a set of required features for the subsequent operator and the list of calculated features to remove the one or more features from the set of required features.

8. The method of claim 1, wherein generating the feature values of the features further comprises:
obtaining a set of documents used as input for calculating the features;
using the list of calculated features and the feature dependency graph to identify a feature to calculate from the set of documents; and
iterating through the set of documents to calculate a first set of feature values for the feature.

9. The method of claim 8, wherein generating the feature values of the features further comprises:
using the list of calculated features and the feature dependency graph to identify a subsequent feature to calculate using the set of documents; and
after the first set of feature values is calculated, iterating through the set of documents to calculate a second set of feature values for the subsequent feature.

10. The method of claim 1, further comprising:
upon detecting a tree structure in an additional operator dependency graph, omitting use of the list of calculated features during evaluation of additional operators in the additional dependency graph.

11. The method of claim 1, wherein the operators comprise at least one of:
a sort operator;
a filtering operator;
a grouping operator;
a union operator;
a limit operator;
a deduplication operator;
an extract operator; and
a user-defined operator.

12. The method of claim 1, wherein the features comprise at least one of:
an input feature for the machine learning model; and
an output score from the machine learning model.

13. A system, comprising:
one or more processors; and
memory storing instructions that, when executed by the one or more processors, cause the system to:
obtain a feature dependency graph of features for a machine learning model and an operator dependency graph comprising operators to be applied to the features;
generate feature values of the features according to an evaluation order associated with the operator dependency graph and feature dependencies from the feature dependency graph;
during evaluation of an operator in the evaluation order, update a list of calculated features with one or more features that have been calculated for use with the operator; and
during evaluation of a subsequent operator in the evaluation order, use the list of calculated features to omit recalculation of the one or more features for use with the subsequent operator.

14. The system of claim 13, wherein obtaining the feature dependency graph and the operator dependency graph comprises:
obtaining a model definition comprising feature declarations of the features and applications of the operators to the features;
generating the feature dependency graph from the feature declarations; and
generating the operator dependency graph from the applications of the operators to the features.

15. The system of claim 13, wherein applying the operators to the features according to the evaluation order and the feature dependencies comprises:
obtaining, from a node in the operator dependency graph, a set of required features for the operator; and
applying the operator to the set of required features.

16. The system of claim 15, wherein applying the operators to the features according to the evaluation order and the feature dependencies further comprises:
using the feature dependency graph to identify additional features as dependencies of the set of required features; and
using the additional features to calculate the set of required features.

17. The system of claim 13, wherein using the list of calculated features to omit recalculation of the one or more features for use with the subsequent operator comprises:
applying a set difference operation to a set of required features for the subsequent operator and the list of calculated features to remove the one or more features from the set of required features.

18. The system of claim 13, wherein generating the feature values of the features further comprises:
obtaining a set of documents used as input for calculating the features;
using the list of calculated features and the feature dependency graph to identify a feature and a subsequent feature to calculate from the set of documents;
iterating through the set of documents to calculate a first set of feature values for the feature; and
after the first set of feature values is calculated, iterating through the set of documents to calculate a second set of feature values for the subsequent feature.

19. The system of claim 13, wherein the operators comprise at least one of:
a sort operator;
a filtering operator;
a grouping operator;
a union operator;
a limit operator;
a deduplication operator;
an extract operator; and
a user-defined operator.

20. A non-transitory computer-readable storage medium storing instructions that when executed by a computer cause the computer to perform a method, the method comprising:
obtaining a feature dependency graph of features for a machine learning model and an operator dependency graph comprising operators to be applied to the features;
generating feature values of the features according to an evaluation order associated with the operator dependency graph and feature dependencies from the feature dependency graph;
during evaluation of an operator in the evaluation order, updating a list of calculated features with one or more features that have been calculated for use with the operator; and
during application of a subsequent operator in the evaluation order to the feature values, using the list of calculated features to omit recalculation of the one or more features for use with the subsequent operator.
